(19) United States
(12) Patent Application Publication
(10) Pub. No.: US 2011/0040839 A1
(43) Pub. Date: Feb. 17, 2011

(54) SYSTEM AND METHOD FOR TRANSACTIONAL STORAGE OF EMAIL DATA

(76) Inventor: Valeriu Zabalan, Bucharest (RO)

Correspondence Address: PERKINS COIE LLP;PATENT-SEA, P.O. BOX 1247, SEATTLE, WA, 98111-1247, US

(21) Appl. No.: 12/739,709

(22) PCT Filed: Oct. 23, 2007
(86) PCT No.: PCT/IB07/03184

§ 371 Date: Nov. 1, 2010

(51) Int. Cl. G06F 15/16

(52) U.S. Cl. 709/206

(57) ABSTRACT

A software and/or hardware facility for storing email data. The facility includes an input component configured to receive emails, a first storage component configured to store a first set of email data, a second storage component configured to store a second set of email data, and a storage manager component. The storage manager component is configured to create a transaction to modify the first and second sets of email data, to modify the first and second sets of email data, to determine if the modification of the first and second sets of email data is successful, and if the modification of the first and second sets of data is successful, to commit the transaction.

### TECHNICAL FIELD

The present invention is directed generally toward electronic messaging systems.

### BACKGROUND

Many organizations employ electronic messaging systems to provide email services for their users. Electronic messaging systems typically store the data associated with user emails as well as configuration data and other data. Such data is typically stored in a single data store, such as a single file. Any operations that modify the data, such as storing new emails, deleting existing emails or modifying existing emails, therefore affect the single file. When completing any modifications to the data, it is important to maintain the accuracy of the data store. Since users often rely upon emails for valuable business and personal communication, it is important to minimize the likelihood that any email data will become corrupted. Electronic messaging systems therefore often use a single data store in order to simplify the maintenance and ensure the integrity of the stored email data.

### BRIEF DESCRIPTION OF THE DRAWINGS

FIG. 1 is a block diagram that illustrates components of a facility for transactionally storing email data.

FIG. 2 is a block diagram that illustrates a data storage unit tree.

FIG. 3 is a flow diagram of a process for creating a transaction for an operation to modify a data storage unit.

FIGS. 4A and 4B are a flow diagram of a process for an operation to modify a data storage unit in a transaction.

FIG. 5 is a flow diagram of a process for retrying an operation to modify a data storage unit in a transaction.

FIGS. 6A and 6B are a flow diagram of a process for registering a data storage unit.

FIG. 7 is a block diagram that illustrates a data storage unit forest.

### DETAILED DESCRIPTION

A software and/or hardware facility for storing email data is disclosed. The facility includes an input component configured to receive emails, a first storage component configured to store a first set of email data, a second storage component configured to store a second set of email data, and a storage manager component. The storage manager component is configured to create a transaction to modify the first and second sets of email data, to modify the first and second sets of email data, to determine if the modification of the first and second sets of email data is successful, and if the modification of the first and second sets of data is successful, to commit the transaction.

Methods of modifying email data are also disclosed. A transaction is executed to modify email data stored in the first and second data storage component. Executing the transaction includes creating a first transaction log for the first data storage unit that specifies the modification, creating a second transaction log for the second data storage unit that specifies the modification, and determining if the first and second transaction logs are successfully created. Executing the transaction further includes determining if the first and second transaction logs are successfully created, and if so, utilizing the first and second transaction logs to modify the first and second data storage units. Executing the transaction further includes determining if the first and second data storage units are successfully modified, and if so, committing the transaction.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### 1. Overview of the Facility

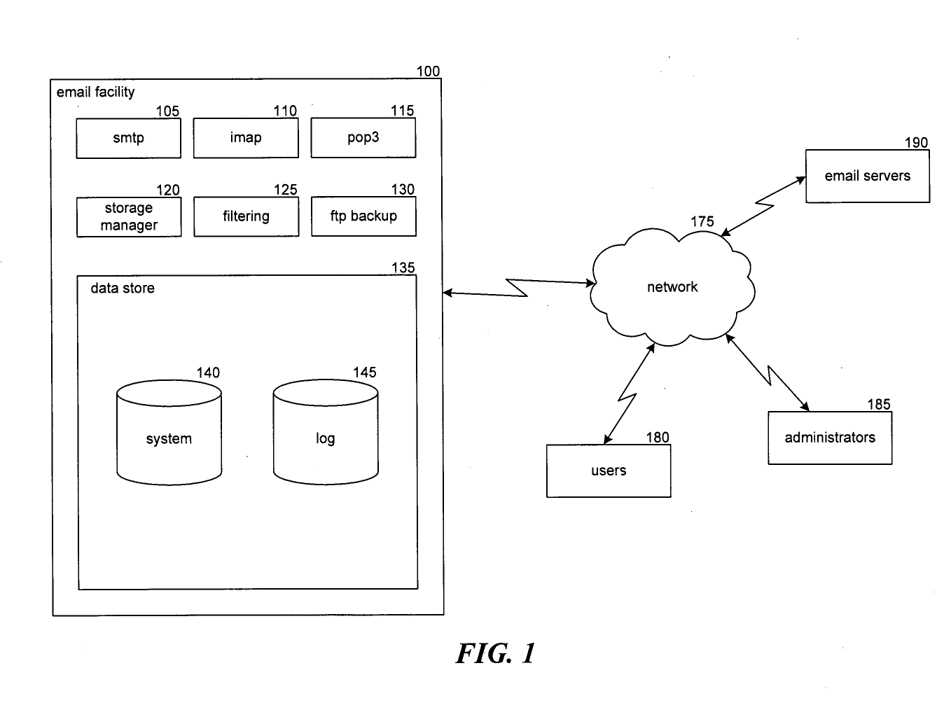

FIG. 1 is a block diagram illustrating components of an electronic mail/electronic message (“email”) software and/or hardware facility 100 (“the facility”). The facility 100 includes various components to implement the functions described herein, including a Simple Mail Transfer Protocol (SMTP) component 105, an Internet Message Access Protocol (IMAP) component 110, a Post Office Protocol 3 (POP3) component 115, a transactional storage component 120, a filtering component 125, a File Transfer Protocol (FTP) backup component 130 and a data store 135. The SMTP component 105 sends and receives emails. The IMAP 110 and POP3 115 components provide access to emails stored by the facility to users. The data store 135 can include data storage units, such as system data storage unit 140, which stores system, email and other data related to the functioning of the facility, and log data storage unit 145, which stores log data that logs aspects of the functioning of the facility. Although depicted as individual data storage units in FIG. 1, the system data storage unit 140 and the log data storage unit 145 can each be comprised of multiple data storage units. The data store 135 can also include other data stores and/or data storage units (not shown), such as an authentication/authorization data storage unit that contains access control lists with permissions or other authentication/authorization information.

The filtering component 125 filters and/or otherwise processes emails in accordance with rules and/or policies defined by administrators of the facility. Aspects of the filtering component 125 are described in further detail in the co-pending patent application entitled SYSTEM AND METHOD FOR FILTERING EMAIL DATA (Attorney Docket No. 66253.8001US00), filed concurrently herewith and incorporated herein in its entirety by reference. The FTP backup component 130 allows connections from FTP clients that enable them to access data stored in the system data storage unit 140 for purposes of backing up and restoring such data. Aspects of the FTP backup component 130 are described in further detail in the co-pending patent application entitled SYSTEM AND METHOD FOR BACKING UP AND RESTORING EMAIL DATA (Attorney Docket No. 66253.8003.US00), filed concurrently herewith and incorporated herein in its entirety by reference. The storage manager component 120 manages interactions with the data storage units, such as the system data storage unit 140. The facility can also include other components (not shown), such as a component that provides a web or internet interface to users for purposes of accessing their emails, a component that provides a web or internet interface to administrators for purposes of administering the facility, and a component that enables administration of the facility with a command-line interface.

Users, such as users 180, can interact with the facility over a network 175, such as the Internet, for purposes of sending and receiving emails. The network 175 can also include an intranet or other private or non-public network. For example, administrators of the facility, such as administrators 185, may access the facility over a private, firewalled network that is only connected to a public network (e.g., the Internet) via a gateway device. The facility can also interact with external servers, such as email servers 190, over the network 175. Other entities (not shown) that may interact with the facility over, through or via the network 175 include routers, firewalls, application servers, database servers and other servers.

### 2. Data Storage Units

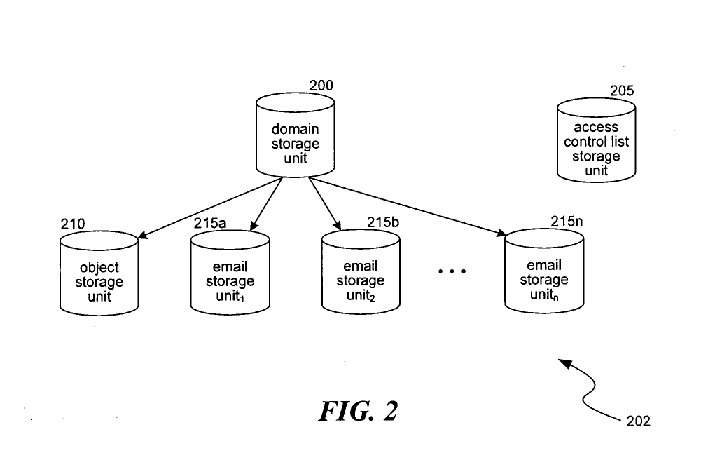

The facility can provide email services for multiple domains (e.g., domains such as axigen.com, gecad.com, gecadtechnologies.com, etc.) which may be related to each other or which each may be unrelated discrete entities. Data associated with each domain includes domain configuration data, configuration data for users within the domain, data for objects within the domain (e.g., objects such as domain mail lists, domain groups, domain public folders, users' folders, etc.), and email data (e.g., the content and addressing information in an email). The system data storage unit 140 stores the data associated with each domain. In some embodiments, the system data storage unit 140 is comprised of multiple individual data storage units. FIG. 2 is a block diagram that illustrates a representative configuration of data storage units. The individual data storage units are organized in a tree-like hierarchical structure hereinafter referred to as data storage unit tree 202. The data storage unit tree 202 corresponds to a single domain for which the facility provides email services. The root node of the data storage unit tree 202 is a domain storage unit 200. The domain storage unit 200 stores configuration data for the domain, names of objects within the domain, and other data. While only one domain storage unit is depicted, it will be appreciated that multiple domain storage units may be present and organized in a larger hierarchical or non-hierarchical structure. The domain storage unit 200 has as children email storage units 215 (shown individually as email storage units 215a-n). The email storage units 215 store emails received by the facility for the domain, data associated with emails, and other data. The domain storage unit 200 can have up to n email storage units, where n is any integer number greater than or equal to one. For example, a data storage unit tree 202 may have a single email storage unit, or a data storage unit tree 202 may have multiple email storage units. The number of email storage units may be easily increased or reduced in order to appropriately scale the storage capacity of the system. The number n of email storage units may be limited by constraints of the facility, such as the available storage space or the limits imposed by the facility's filesystem. The domain storage unit 200 also has as a child an object storage unit 210. The object storage unit 210 stores configuration data for objects within the domain, the structure of those objects, and other data. For example, each user within the domain has a mailbox with one or more folders arranged in a hierarchical structure. The object storage unit 210 stores data related to the hierarchical structure of the users' folders. The object storage unit 210 also stores a reference (e.g., a pointer) to the emails stored in the email storage units 215. Storing a reference to the emails in the object storage unit 210 allows the facility to avoid duplicative storing of emails, thereby optimizing available storage capacity. For example, if two users within a domain both receive the same email, the facility can store the email in one of the email storage units 215 and a reference to the email for each user in the object storage unit 210. Each data storage unit in the data storage unit tree 202 has a unique identifier. Each data storage unit also includes a reference to the unique identifier of its parent, if it has one, and its children, if it has any. The facility uses the unique identifiers of the data storage units to maintain the hierarchical structure of the data storage unit tree 202.

Although not depicted as part of the data storage unit tree 202, the facility's data store 135 can also include an access control list storage unit 205. The access control list storage unit 205 can store data that the facility can use both to authenticate users as well as to determine if an authenticated user is authorized to access the data stored by the facility. For example, the access control list storage 205 can store authentication information that the facility can use to authenticate users wishing to access the facility. As another example, the access control list storage 205 can include access control lists that the facility can use to determine if a user, once authenticated, is authorized to access data stored by the facility. The data store 135 can include one or more access control list storage units 205 for each domain for which the facility provides services. Alternatively, the data store 135 can include one or more access control list storage units 205 that are used for all of the facility's domains.

### 3. Transactions

The facility implements transactions for operations that modify the data in the data storage units. A transaction refers to an interaction with one or more data storage units that the facility treats independently of other interactions. A transaction generally must be atomic, meaning that it must be either entirely completed or aborted. If a transaction is aborted, ideally, any changes to data in the data storage units should be rolled back, thus putting the data in the data storage units in the state it was in before the commencement of the transaction. The facility implements transactions for various reasons. One reason is that data is stored in multiple data storage units. Any operation that modifies the data should modify all of the necessary data storage units, in order to ensure that the data is consistent throughout the multiple data storage units. If the operation is interrupted in any fashion, which can occur if a data storage unit becomes unavailable or for other reasons, the operation may not be completed. In that case, the operation should be rolled back to ensure data consistency. Implementing transactions for operations that modify data enables the facility to maintain consistent data throughout the multiple data storage units.

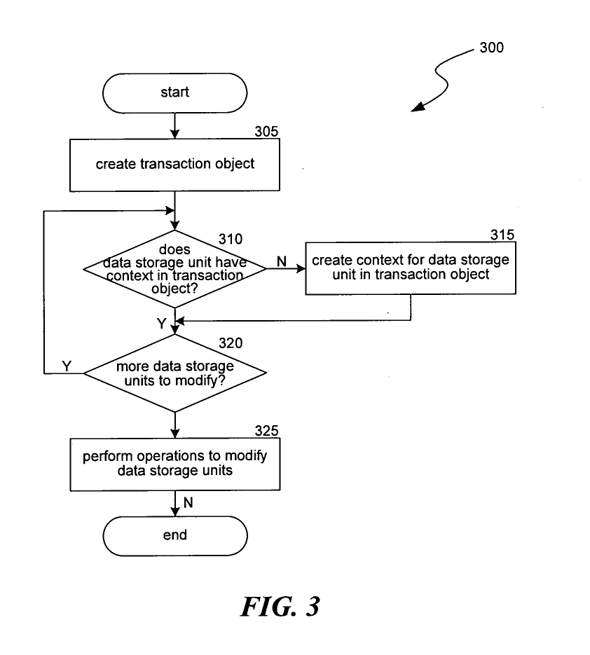

FIG. 3 is a flow diagram of a process 300 for creating a transaction for an operation to modify a data storage unit. An operation to modify a data storage unit refers to any operation that modifies the data in the data storage unit, such as inserting new data, updating existing data or deleting existing data. Examples of operations that modify data storage units include, but are not limited to, the following: adding a new user; adding configuration data related to or associated with the new user; sending a welcome or initial email to the new user; adding permissions/authorization information for the new user; storing a received email; storing a reference to a received email; deleting a user; deleting configuration data related to or associated with the user; deleting the emails related to or associated with the user; modifying an email; modifying a reference to the email; modifying user configuration data; and modifying user permissions/authorization information. Operations other than those listed are of course possible.

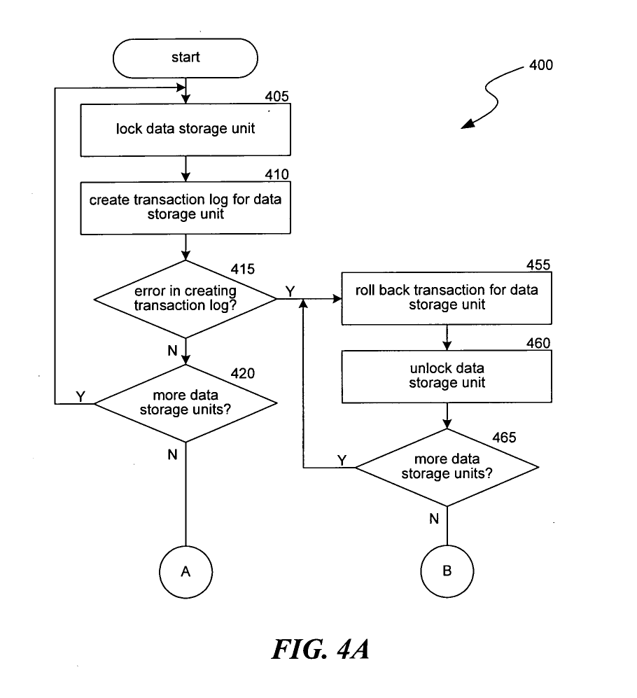

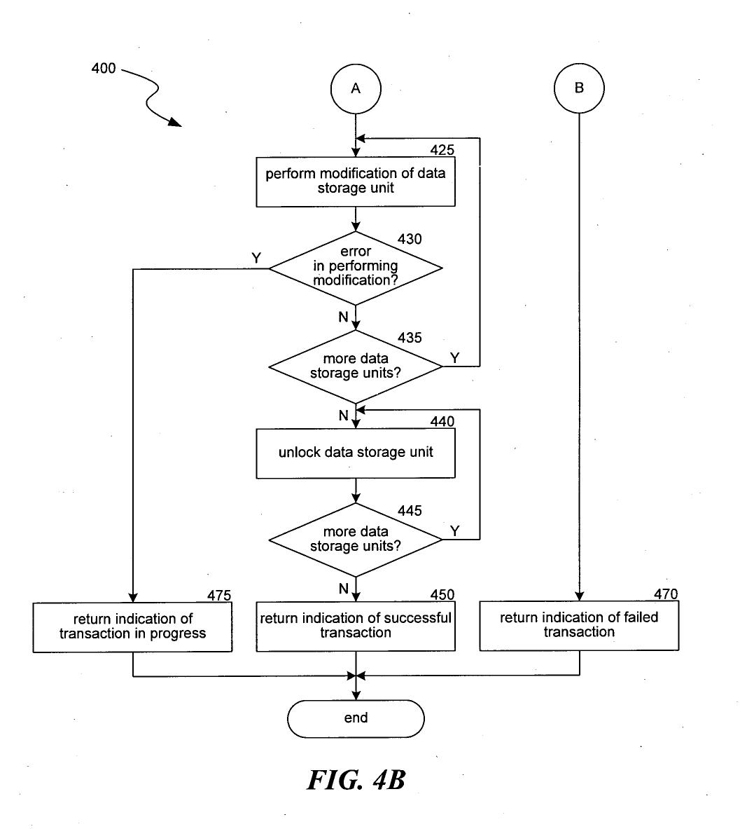

The process 300 begins at block 305 when the facility creates a transaction object. Each data storage unit involved in the operation has a transactional context. The transaction object holds the transactional context for each data storage unit involved in the operation. The process 300 continues at decision block 310 in which the facility determines whether the data storage unit to be modified has a context in the transaction object. If the data storage unit to be modified has a context in the transaction object the process 300 continues to decision block 320. If not, the process 300 continues at block 315, in which the facility creates a context for the data storage unit in the transaction object. The process 300 then continues at decision block 320, in which the facility determines whether there are more data storage units involved in the operation. If so, the process 300 returns to decision block 310. If not, the process 300 continues at block 325, in which the facility performs the operation to modify the data storage unit. The operation to modify the data storage unit is described in FIGS. 4A and 4B. The process 300 then ends.

FIGS. 4A and 4B are a flow diagram of a process 400 for an operation to modify a data storage unit in a transaction. An operation to modify a data storage unit takes place inside the transactional context created for the data storage unit. The process 400 begins at block 405, in which the facility locks the first data storage unit involved in the transaction. Locking, which is well known in the art, refers to preventing concurrent access by other users or processes to the locked data. Locking a data storage unit in this context can refer to either locking the entire data storage unit or locking only the data to be modified in the data storage unit. At block 410 the facility creates a transaction log for the first data storage unit. In some embodiments, the transaction log includes two aspects. A first aspect is a record of the modifications that must be performed on the data storage unit in order for the transaction to be successful. In some embodiments, the record of the modifications to be performed must be idempotent, meaning that performing the modifications multiple times will have the same affect on the data as performing the modifications a single time. A second aspect is a list of all the data storage units involved in the transaction. In some embodiments, the facility uses each data storage unit's unique identifier in the list in order to identify all data storage units involved in the transaction. At decision block 415 the facility determines if an error occurred in creating the transaction log. If an error occurred, the process 400 continues at block 455, in which the facility rolls back the transaction for the first data storage unit. The facility can roll back the transaction by undoing any modifications to the data storage unit, such as by deleting the transaction log. At block 460 the facility unlocks the first data storage unit involved in the transaction. At decision block 465 the facility determines whether there are more locked data storage units involved in the transaction. If so, the process 400 returns to block 455 and rolls back the transaction for another data storage unit. The process repeats blocks 455, 460 and 465 until the transaction has been rolled back for all data storage units and all data storage units are unlocked. The process 400 then continues at block 470, in which the facility returns an indication of a failed transaction, thereby ending the process 400.

If, at decision block 415, there were no errors in creating the transaction log for the first data storage unit involved in the transaction, the process 400 continues at decision block 420. At decision block 420 the facility determines whether there are more data storage units involved in the transaction. If there are, the process 400 returns to block 405 where another data storage unit involved in the transaction is locked and a transaction log is created for the data storage unit. The process repeats blocks 405-420 until all data storage units involved in the transaction are locked and have an associated transaction log. If no additional data storage units are involved in the transaction at decision block 420, the process 400 continues at block 425, in which the facility performs the operation to modify the first data storage unit involved in the transaction. As previously described, an operation to modify a data storage unit refers to any operation that modifies the data in the data storage unit, such as inserting new data, updating existing data or deleting existing data. At decision block 430 the facility determines if there was an error in performing the operation to modify the first data storage unit. If there was an error, the process 400 continues at block 475, in which the facility returns an indication that a transaction is in progress. If there were no errors, the process 400 continues at decision block 435, in which the facility determines if there are more data storage units involved in the transaction. If so, the process 400 returns to block 425 to perform the operation to modify another data storage unit involved in the transaction. The process repeats blocks 405-435 until all data storage units involved in the transaction have been modified. If the facility has performed the operations to modify all the data storage units involved in the transaction without error at decision block 435, the process continues at block 440. At block 440 the facility unlocks the first data storage unit involved in the transaction. At decision block 445 the facility determines whether there are additional locked data storage units involved in the transaction; if so the process 400 returns to block 440 to unlock another data storage unit involved in the transaction. The process repeats blocks 440-445 until all data storage units involved in the transaction have been unlocked. When all data storage units involved in the transaction have been unlocked the process 400 continues at block 450, in which the facility returns an indication of a successful transaction.

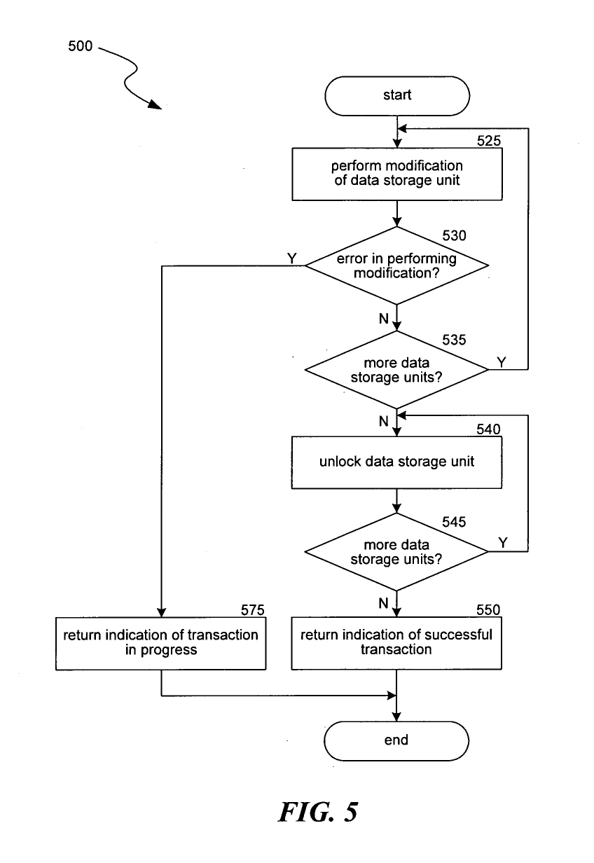

FIG. 5 is a flow diagram of a process 500 for retrying an operation to modify one or more data storage units in a transaction. The facility can retry or re-attempt an operation to modify one or more data storage units in a transaction after the facility returns an indication that a transaction is in progress (block 470 of FIG. 4). The process 500 begins at block 525, in which the facility attempts to perform an operation to modify a data storage unit involved in the transaction. At decision block 530 the facility determines if there was an error in performing the operation to modify the data storage unit. If there was an error, the process 500 continues at block 575, in which the facility returns an indication that a transaction is in progress. If there were no errors, the process 500 continues at decision block 535, in which the facility determines if there are more data storage units involved in the transaction. If so, the process 500 returns to block 525 and a modification is attempted on another data storage unit. If not, meaning that the facility has performed the operation to modify all the data storage units involved in the transaction without error, the process continues at block 540. At block 540 the facility unlocks a data storage unit involved in the transaction. At decision block 545 the facility determines whether there are additional locked data storage units involved in the transaction; if so the process 500 returns to block 540 and unlocks another data storage unit. When all data storage units involved in the transaction have been unlocked the process 500 continues at block 550, in which the facility returns an indication of a successful transaction.

One advantage of the processes described with reference to FIGS. 3-5 is that implementing transactions for operations that modify data enables the facility to maintain consistent data throughout the multiple data storage units. For example, if a user of an organization for which the facility provides email services leaves the organization, the data associated with that user is generally deleted. For the facility, this would require deleting the data associated with the user in the organization's domain. In some embodiments, deletion of this data entails removing all the emails owned by the user (affecting one or more email storage units), removing user configuration data and the user's folder structure (affecting the object storage unit) and removing the user name and any aliases associated with the user (affecting the domain storage unit). Ideally, all of this data should be removed from the necessary storage units, in order to maintain data consistency. When these operations are performed in a transaction, the facility either removes all of the data from all of the necessary data storage units, in which case the transaction succeeds, or the facility is unable to remove all of the data from all of the necessary data storage units, in which case the transaction fails. When the transaction fails, the facility can either re-attempt the transaction or roll back the transaction. If the transaction is rolled back, the data in the data storage units is returned to the state it was in before the transaction was first attempted. Implementing the deletion of user data in a transaction enables the facility to maintain consistent data throughout its multiple data storage units. As another example, if an organization wishes to add a user, the facility can do so in a transaction that creates an account/user name for the user (affecting the domain storage unit), creating the user configuration data and the user's folder structure (affecting the object storage unit) and sending the user an initial email message (affecting one or more email storage units). Therefore, implementing adding a user in a transaction also enables the maintenance of consistent data throughout the multiple data storage units.

### 4. Registering a Data Storage Unit

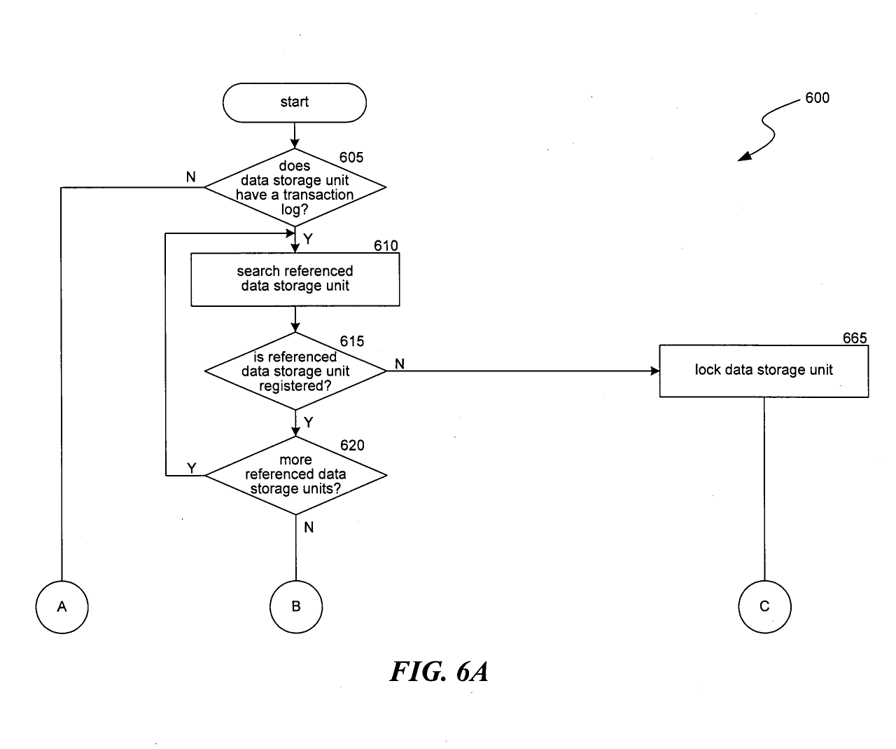

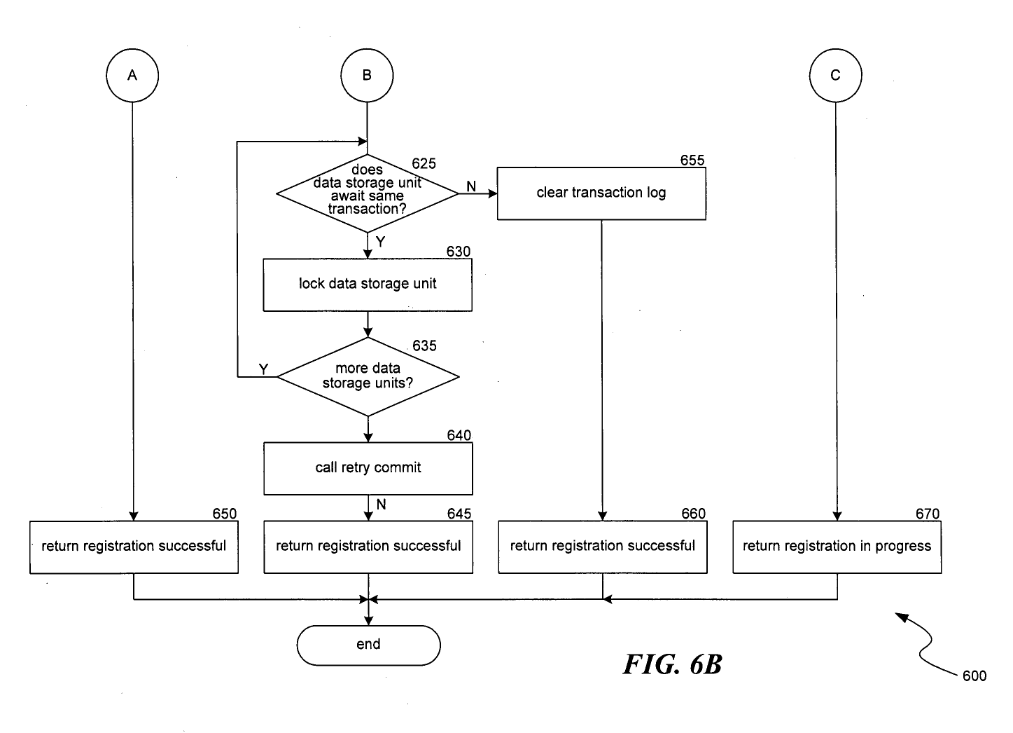

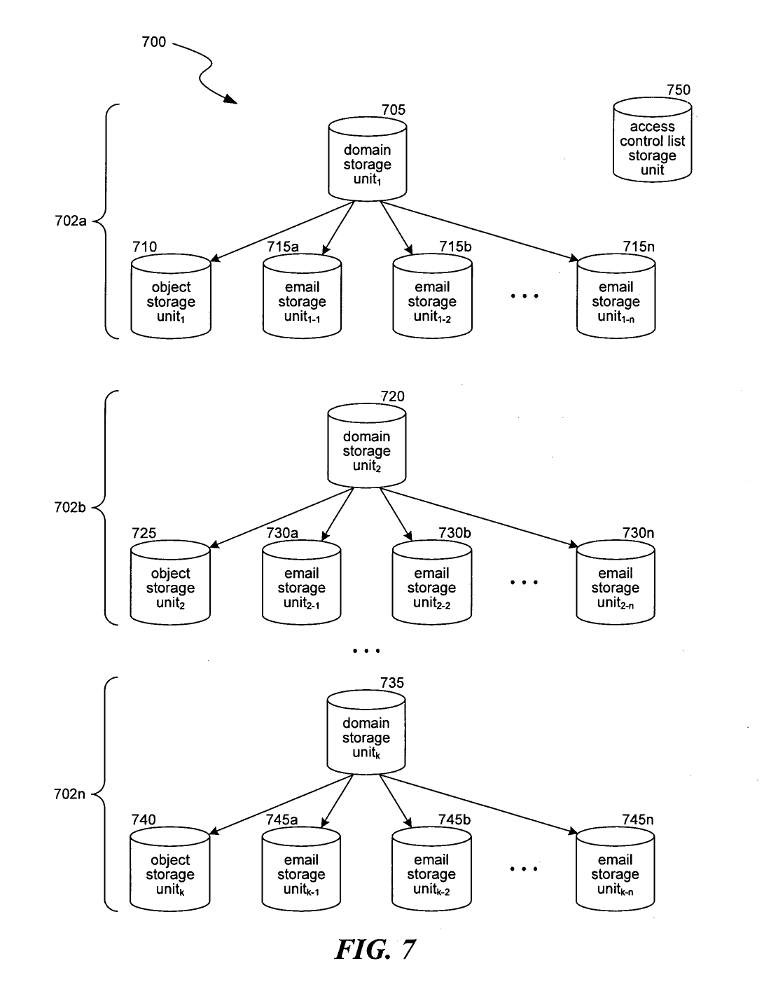

FIGS. 6A and 6B are a flow diagram of a process 600 for registering a data storage unit, such as the data storage units described with reference to, e.g., FIGS. 2 and 7. The facility generally has to register data storage units before they are available for use. If an existing data storage unit is taken offline, the facility has to re-register it before it can be used again. An existing data storage unit may be taken offline for various reasons. For example, a single existing data storage unit may be located on a physical hard drive. An administrator of the facility may wish to replace the physical hard drive with a different physical hard drive. In that case, the administrator can take the single existing data storage unit offline, transfer it to the different physical hard drive, and then re-register the single existing data storage unit to allow it to be used again. The facility also has to register a new data storage unit before it can be used. The administrator may add a new data storage unit for various reasons, such as for additional storage capacity or to provide redundancy of the data stored in the data storage units.

The process 600 for registering a data storage unit begins at decision block 605 in which the facility determines whether the data storage unit includes a transaction log. The facility checks for a transaction log because the presence of a transaction log may indicate that the data storage unit is involved in a transaction in progress that may require completion before it can be registered. If the facility determines that the data storage unit does not include a transaction log the process continues at block 650, in which the facility registers the data storage unit and returns an indication of a successful registration.

If, at block 605 the facility determines that the data storage unit includes a transaction log, the process continues at block 610, in which the facility examines the transaction log to identify the other data storage units involved in the transaction in progress. As previously mentioned, each data storage unit has a unique identifier. The transaction log includes the unique identifier or other indication of each data storage unit involved in the transaction in progress. At decision block 615 the facility determines if the other data storage units referenced in the transaction log are already registered. If the other data storage units are not registered, the process 600 continues at block 665. At block 665 the facility locks the data storage unit and returns an indication of a registration in progress at block 670. The facility does so in order to put the data storage unit into a waiting state so that it can register the other data storage units. The process 600 then ends.

If, at block 615, the facility determines that the referenced data storage unit is already registered, the process continues at decision block 620, in which the facility determines whether there are more data storage units referenced in the transaction log. If so, the process returns to block 610 in order to examine the transaction log of another data storage unit and determine if data storage units referenced in that transaction log are registered. If not, the process continues at decision block 625. At decision block 625 the facility determines whether the referenced data storage unit awaits the same transaction in progress. If not, the facility clears the transaction log at block 655. The process 600 then continues at block 660, in which the facility registers the data storage unit and returns an indication of a successful registration.

If, at block 625, the facility determines that the referenced data storage unit awaits the same transaction in progress, the process continues at block 630, in which the facility locks the referenced data storage unit. At block 635 the facility determines whether there are more data storage units that have been referenced in the transaction log. If so, the process 600 returns to block 625 to lock another data storage unit reference in the transaction log. If not, the process 600 continues at block 640, in which the facility attempts to complete the same transaction in progress for all the data storage units that have been referenced in the transaction log. This can be done by performing process 500 for retrying an operation to modify one or more data storage units in a transaction (as depicted in FIG. 5). At the completion of this process, at block 645 the facility registers the data storage units and returns an indication of a successful registration.

One advantage of the process 600 for registering a data storage unit described with reference to FIGS. 6A and 6B is that it enables the facility to complete any transactions in progress that the data storage unit is involved in. For example, a registered data storage unit may be involved in a transaction when it experiences an error that halts the transaction. An administrator of the facility can take the affected data storage unit offline, repair the error, and then re-register the data storage unit, which will allow the facility to complete the transaction that the data storage unit is involved in.

### 5. Data Storage Unit Forest

FIG. 7 is a block diagram that illustrates a data storage unit forest 700. The data storage unit forest 700 includes multiple individual data storage unit trees 702 (shown individually as data storage unit trees 702a-n). Each of the data storage unit trees 702 is similar to the data storage unit tree 202 described with reference to FIG. 2. In the depicted example, each data storage unit tree 702 includes a domain storage unit, an object storage unit, and multiple email storage units. The data storage unit forest 700 also includes an access control list storage unit 750, which can function similarly to the access control list storage unit 205 described with reference to FIG. 2 except applied across the entire forest. Each data storage unit tree 702 can be associated with a domain for which the facility provides email services. In some embodiments, the domains may be related entities. If the domains are related entities, their corresponding data storage unit trees 702 may be aware of each other. For example, one domain may be a subdomain of another domain (e.g., webmail.axigen.com is a subdomain of axigen.com). In such instances, the data storage unit tree 702 of the subdomain may include a reference to the data storage unit tree 702 of its parent domain, and vice-versa. In other embodiments, however, the domains are unrelated entities and their corresponding data storage unit trees 702 are not aware of each other. One advantage of the facility's implementation of the data storage unit forest 700 is that it enables the facility to segregate data associated with multiple domains into a unique data storage unit tree for each domain.

### 6. Conclusion

The foregoing description details certain embodiments of the invention. It will be appreciated, however, that no matter how detailed the foregoing appears in text, the invention can be practiced in many ways. For example the facility can be implemented as a distributed computing system, with components of the facility being implemented and/or executed on disparate systems that are connected over a network. The facility could equally well be executed as a standalone system. Moreover, the facility may utilize third-party services and data to implement all or portions of its functionality. Although the subject matter has been described in language specific to structural features and/or methodological steps, it is to be understood that the subject matter defined in the claims is not necessarily limited to the specific features or steps described. Rather, the specific features and steps are disclosed as preferred forms of implementing the claimed subject matter.

The above Detailed Description of embodiments of the invention is not intended to be exhaustive or to limit the invention to the precise forms disclosed. While various embodiments are described in terms of the environment described above, those skilled in the art will appreciate that various changes to the facility may be made without departing from the scope of the invention. For example, those skilled in the art will appreciate that the actual implementation of the data store 135 may take a variety of forms. The term “data store” is used herein in the generic sense to refer to any data structure that allows data to be stored and accessed, such as databases, tables, linked lists, arrays, etc. As another example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

These and other changes can be made to the invention in light of the above Detailed Description. Accordingly, the actual scope of the invention encompasses not only the disclosed embodiments, but also all equivalent ways of practicing or implementing the invention under the final claims.

I/We claim:

1. An email system for storing email data, the system comprising:
an input component configured to receive emails;
a first storage component configured to store a first set of data, wherein the first set of data includes received emails;
a second storage component configured to store a second set of data related to the received emails; and
a storage manager component configured to:
create a transaction to modify the first and second sets of data;
modify the first and second sets of data;
determine if the modification of the first and second sets of data is successful; and
if the modification of the first and second sets of data is successful, commit the transaction.

2. The email system of claim 1 wherein if the modification of the first and second sets of data is not successful, the storage manager component is further configured to again modify the first and second sets of data.

3. The email system of claim 1 wherein the storage manager component is further configured to:
create a first transaction log for the first storage component that references the modification of the first set of data;
create a second transaction log for the second storage component that references the modification of the second set of data; and
utilize the first and second transaction logs to modify the first and second sets of data.

4. The email system of claim 3 wherein the storage manager component is further configured to:
determine if the first and second transaction logs are not successfully created; and
if the first and second transaction logs are not successfully created, to abort the transaction.

5. The email system of claim 1 wherein the storage manager component is further configured to:
create a transaction object for executing the transaction;
create a first transactional context for the first storage component in the transaction object;
create a second transactional context for the second storage component unit in the transaction object; and
utilize the first and second transactional contexts to modify the first and second sets of data.

6. The email system of claim 1 wherein the storage manager component is further configured to:
lock the first and second sets of data; and
if the modification of the first and second sets of data is successful, unlock the first and second sets of data.

7. The email system of claim 1 wherein if the modification of the first and second sets of data is not successful, the storage manager component is further configured to roll back the transaction.

8. The email system of claim 1 wherein the first and second sets of data are associated with a domain, the transaction to modify the first and second sets of data includes storing a received email in the first set of data and storing user data associated with the email in the second set of data and, and the storage manager component is further configured to:
store the email in the first set of data;
store the user data in the second set of data;
determine if the modifications are successful; and
if the modifications are successful, commit the transaction.

9. The email system of claim 1, further comprising an access control list storage component configured to store a third set of data, wherein the third set of data includes access control list data.

10. The email system of claim 1 wherein the first and second storage components are associated with a first domain, and further comprising:
a third storage component configured to store a third set of data, wherein the third set of data includes received emails;
a fourth storage component configured to store a fourth set of data related to the received emails; and
wherein the third and fourth storage components are associated with a second domain.

11. The email system of claim 1 wherein the second set of data related to the received emails includes references to the received emails and when the input component receives an email, the storage manager component is further configured to store the email in the first set of data and store a reference to the email in the second set of data.

12. A method of modifying email data stored in an email system having first and second data storage units to execute a transaction, the method comprising:
creating a first transaction log for a first data storage unit that stores emails, wherein the first transaction log specifies a modification associated with a transaction;
creating a second transaction log for a second data storage unit that stores information related to the emails, wherein the second transaction log specifies a modification associated with the transaction;
determining if the first and second transaction logs are successfully created;
if the first and second transaction logs are successfully created, utilizing the first and second transaction logs to modify the first and second data storage units;
determining if the first and second data storage units are successfully modified; and
if the first and second data storage units are successfully modified, committing the transaction.

13. The method of claim 12, further comprising:
creating a transaction object for executing the transaction;
creating a first transactional context for the first data storage unit in the transaction object;
creating a second transactional context for the second data storage unit in the transaction object; and
utilizing the first and second transactional contexts to modify the first and second data storage units.

14. The method of claim 12, wherein executing the transaction further includes:
locking the first and second data storage units; and
if the first and second data storage units are successfully modified, unlocking the first and second data storage units.

15. The method of claim 12 wherein:
utilizing the first and second transaction logs to modify the first and second data storage units is a first attempt; and
if the first and second data storage units are not successfully modified in the first attempt, utilizing the first and second transaction logs to modify the first and second data storage units in a second attempt.

16. The method of claim 12 wherein if the first and second transaction logs are not successfully created, the transaction is aborted.

17. The method of claim 12 wherein if the first and second data storage units are not successfully modified, the transaction is rolled back.

18. The method of claim 12 wherein:
the modification specified in the second transaction log includes adding a new user;
the modification specified in the first transaction log includes adding an email associated with the new user; and
utilizing the first and second transaction logs to modify the first and second data storage units includes utilizing the second transaction log to add the new user to the second data storage unit and utilizing the first transaction log to add the email to the first data storage unit.

19. The method of claim 18 wherein the modification specified in the second transaction log further includes adding configuration data associated with the new user and utilizing the second transaction log to modify the second data storage unit includes utilizing the second transaction log to add the configuration data to the second data storage unit.

20. The method of claim 12 wherein the first transaction log further specifies a reference to the second transaction log.

21. The method of claim 12 wherein:
the information related to the emails includes references to the emails;
the modification specified in the first transaction log includes adding an email;
the modification specified in the second transaction log includes adding a reference to the email; and
utilizing the first and second transaction logs to modify the first and second data storage units includes utilizing the first and second transaction logs to add an email to the first data storage unit and to add a reference to the email to the second data storage unit.

22. A method of registering a storage unit in an email system, the method comprising:
determining if a first storage unit includes a first transaction log that references a transaction involving a second storage unit;
if the first storage unit includes a first transaction log, determining if the second storage unit is already registered;
if the second storage unit is not already registered, determining if the second storage unit includes a second transaction log that references the transaction; and
if the second storage unit includes a second transaction log that references the transaction:
executing the transaction; and
registering the first storage unit.

23. The method of claim 22 wherein if the second storage unit includes a second transaction log that references the transaction, further comprising registering the second storage unit.

24. The method of claim 22 wherein if the second storage unit includes a second transaction log that references the transaction, further comprising:
locking the first storage unit; and
unlocking the first storage unit.

25. The method of claim 22 wherein if the second storage unit does not include a second transaction log that references the transaction, further comprising clearing the first transaction log.
